(19) United States
(12) Patent Application Publication
(10) Pub. No.: US 2017/0241631 A1
(43) Pub. Date: Aug. 24, 2017

(54) FLUORESCENT LIGHT SOURCE APPARATUS

(71) Applicant: USHIO DENKI KABUSHIKI KAISHA, Tokyo (JP)

(72) Inventor: Kazunori BESSHO, Tokyo (JP)

(73) Assignee: USHIO DENKI KABUSHIKI KAISHA, Tokyo (JP)

(21) Appl. No.: 15/521,646

(22) PCT Filed: Oct. 9, 2015
(86) PCT No.: PCT/JP2015/078769

§ 371 Date: Apr. 25, 2017

(30) Foreign Application Priority Data
Oct. 27, 2014 (JP) 2014-218134

(51) Int. Cl. F21V 29/502; F21V 29/76; F21V 29/89; F21V 8/00; F21K 9/64

(52) U.S. Cl. CPC F21V 29/502; G02B 6/0008; G02B 6/0006; F21K 9/64; F21V 29/89; F21V 29/763; F21Y 2115/30

(57) ABSTRACT

An object of the present invention is to provide a fluorescent light source apparatus that is capable of efficiently cooling a fluorescent member and holding the fluorescent member at a proper position relative to a reflector and is thus capable of stably providing a high light output over a long period of time. A fluorescent light source apparatus according to the present invention has a configuration in which a fluorescent member that generates fluorescence upon application of excitation light thereto and a reflector having a reflective surface disposed so as to face an excitation light receiving surface of the fluorescent member are held by a common holding structure formed of a heat conductive material. The holding structure includes a cylindrical base part, and a heat conducting part formed so as to extend from an inner circumferential surface of the base part toward a center axis of the base part. The fluorescent member is held so as to be positioned on the center axis of the base part, on a side surface of the heat conducting part of the holding structure, the side surface facing the reflective surface of the reflector.

### TECHNICAL FIELD

The present invention relates to a fluorescent light source apparatus that generates fluorescence using laser light.

### BACKGROUND ART

Currently, techniques using a fluorescent light source apparatus, for example, as an illumination light source are known. A fluorescent light source apparatus is one that excites a fluorescent material by means of light from a solid-state light source such as, for example, a semiconductor laser and outputs light generated from the fluorescent material.

However, since upon receipt of excitation light, the fluorescent material converts a part of energy of the light into heat energy, in such fluorescent light source apparatus, the fluorescent material generates heat as a result of application of laser light to the fluorescent material. There is a problem in that generation of high-temperature heat by the fluorescent material results in a decrease in amount of fluorescence generated from the fluorescent material due to temperature quenching and thus results in a decrease in light emission efficiency. Therefore, it is necessary to efficiently release the heat generated in the fluorescent material.

For example, where such fluorescent light source apparatus is used as an illumination light source, it is necessary that the fluorescent light source apparatus be capable of providing a large amount of light, for example, a light flux of around 7000 [lm] for far illumination. More specifically, for example, in order to provide a light flux of 7000 [lm] using a white fluorescence source having a luminous efficacy of 350 [lm/W], a light output of 20 W is required. Here, if an external quantum efficiency is 50%, it is necessary to cool the fluorescent material with an exhaust heat amount (20 W) equivalent to the light output.

FIG. 5 is a cross-sectional view illustrating a schematic configuration of an example of a conventional fluorescent light source apparatus along an optical axis of a reflector.

The fluorescent light source apparatus includes an excitation light source 70 comprising a semiconductor laser array, a light-emitting section 75 including a fluorescent material that generates fluorescence by laser light from the excitation light source 70, a reflector 80 having a reflective surface disposed so as to face the light-emitting section 75, and a transparent plate 81 covering an opening portion of the reflector 80. In FIG. 5, reference numeral 71 denotes a semiconductor laser, reference numeral 72 denotes an aspherical lens, and reference numeral 73 denotes an optical fiber that guides laser light from the excitation light source 70. The light-emitting section 75 is held and thereby fixed between a plate-like heat transfer member 85 connected to a cooling section 86 so as to transfer heat and the transparent plate 81. Reference numeral 76 denotes a spacer layer formed of an adhesive. Such fluorescent light source apparatus is disclosed in Patent Literature 1.

### CITATION LIST

### Patent Literature

### Patent Literature 1: Japanese Patent No. 5021089

### SUMMARY OF INVENTION

### Technical Problem the Invention to Solve

In such fluorescent light source apparatus, as described above, a part of light energy of laser light entering the light-emitting section 75 is converted into heat energy, which increases temperatures of the light-emitting section 75 and the heat transfer member 85 holding the light-emitting section 75. Also, the laser light is partially absorbed by the heat transfer member 85 and heat is thereby generated, which also increases the temperatures. Upon the increase in temperature of the heat transfer member 85, the heat transfer member 85 deforms because of heat expansion, resulting in change in positional relationship between the light-emitting section 75 and the reflector 80. As a result, there is a problem in that an output and/or distribution of light emitted from the fluorescent light source apparatus change.

The present invention has been made based on such circumstances as above, and an object of the present invention is to provide a fluorescent light source apparatus that is capable of efficiently cooling a fluorescent member and holding the fluorescent member at a proper position relative to a reflector and is thus capable of stably providing a high light output over a long period of time.

### Solution to Problem

A fluorescent light source apparatus according to the present invention is a fluorescent light source apparatus comprising a fluorescent member that generates fluorescence upon application of excitation light thereto, and a reflector having a reflective surface disposed so as to face an excitation light receiving surface of the fluorescent member, wherein:

the fluorescent member and the reflector are held by a common holding structure formed of a heat conductive material, the holding structure including a cylindrical base part and a heat conducting part formed so as to extend from an inner circumferential surface of the base part toward a center axis of the base part; and

the fluorescent member is held so as to be positioned on the center axis of the base part, on a side surface of the heat conducting part of the holding structure, the side surface facing the reflective surface of the reflector.

In the fluorescent light source apparatus according to the present invention, it is preferable that:

the holding structure includes a plurality of the heat conducting parts having a plate-like shape with respective inner end portions mutually joined on the center axis of the base part; and

each of the plurality of the heat conducting parts is disposed in such a manner that the holding structure has an axisymmetric structure.

Furthermore, in the fluorescent light source apparatus according to the present invention, it is preferable that an opening on a one-end side of the holding structure is occluded by a window member and an opening on the other-end side of the holding structure is occluded by an occluding member, whereby a space in which the fluorescent member is positioned is a closed space.

### Advantageous Effects of Invention

According to the fluorescent light source apparatus of the present invention, heat generated in the fluorescent member is transferred to the base part via the heat conducting part of the holding structure and is radiated to the outside from the entire base part, and thus, a decrease in amount of fluorescence generated from the fluorescent member due to temperature quenching accompanying an increase in temperature of the fluorescent member can be avoided. Therefore, the fluorescent light source apparatus having the above configuration can stably provide a high light output over a long period of time.

Also, the holding structure includes the plurality of the heat conducting parts with respective inner end portions mutually joined on the center axis of the base part, and each of the plurality of the heat conducting parts is disposed in such a manner that the holding structure has an axisymmetric structure, whereby a degree of change in positional relationship between the fluorescent member and an optical member such as the reflector accompanying an increase in temperature of the holding structure can be suppressed to be small and a desired light output can be provided.

Furthermore, the fluorescent member disposition space in which the fluorescent member is positioned is a closed space, and thus, occurrence of problems such as a decrease in light emission efficiency of the fluorescent member and deterioration of the fluorescent member itself due to entry of water and/or dust and the like into the fluorescent member disposition space can be avoided.

### BRIEF DESCRIPTION OF DRAWINGS

FIG. 1 shows a front view illustrating a schematic configuration of an example of a fluorescent light source apparatus according to the present invention.

FIG. 2 shows a cross-sectional view along line A-A in FIG. 1.

FIG. 3 shows a perspective view schematically illustrating a fluorescent member holding structure in the fluorescent light source apparatus illustrated in FIG. 1.

FIG. 4 shows a cross-sectional view schematically illustrating an example configuration of a reflector along an optical axis.

FIG. 5 shows a cross-sectional view illustrating a schematic configuration of an example of a conventional fluorescent light source apparatus along an optical axis of a reflector.

### DESCRIPTION OF EMBODIMENT

An embodiment of the present invention will be described in detail below.

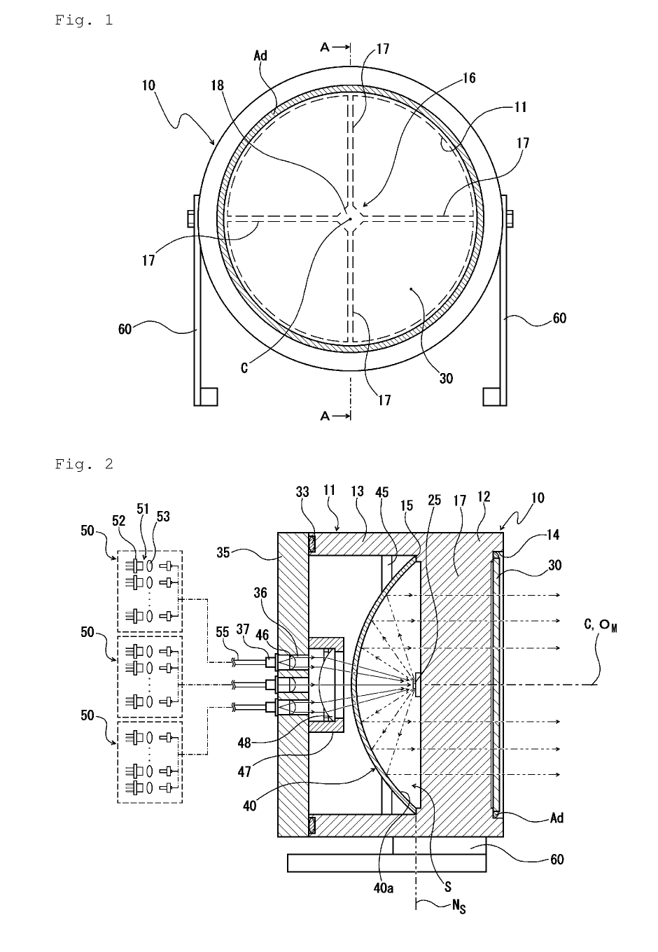

FIG. 1 is a front view illustrating a schematic configuration of an example of a fluorescent light source apparatus according to the present invention. FIG. 2 is a cross-sectional view along line A-A in FIG. 1. FIG. 3 is a perspective view schematically illustrating a fluorescent member holding structure in the fluorescent light source apparatus illustrated in FIG. 1.

The fluorescent light source apparatus includes a fluorescent member 25 that generates fluorescence upon application of excitation light thereto, and the fluorescent member 25 is held by a cylindrical holding structure 10. The fluorescent member 25 is formed of a fluorescent plate 26 comprised of, for example, a YAG fluorescent material activated with cerium (light emission wavelength 550 nm).

The holding structure 10 is formed of, for example, a heat conductive material such as aluminum or an aluminum alloy, and includes a cylindrical base part (rim) 11 and a plurality of heat conducting parts (spokes) 16 extending from an inner circumferential surface of the base part 11 toward a center axis C of the base part 11 and forming a heat transfer passageway for heat exhaust from the fluorescent member 25. Here, reference numeral 60 in FIGS. 1 and 2 denotes a support leg portion formed of, for example, an aluminum alloy.

The base part 11 includes a one end-side cylindrical portion 12, and the other end-side cylindrical portion 13 that is continuous with the opposite end to the one end-side cylindrical portion 12 via a step portion 15. The other end-side cylindrical portion 13 has an inner diameter that is larger than that of the one end-side cylindrical portion 12.

Each of the plurality of heat conducting parts 16 is formed of, for example, a heat conducting plate 17 having a flat plate shape extending along the center axis C of the base part 11, and is disposed in such a manner that the holding structure 10 has an axisymmetric structure in an inner circumferential surface of the one end-side cylindrical portion 12 of the base part 11. More specifically, the four heat conducting plates 17 are disposed at respective positions that are axisymmetric with reference to a center line in a thickness direction of one of the heat conducting plates 17 in a cross-section perpendicular to the center axis C of the base part 11. Inner end portions in a radial direction of the heat conducting plates 17 are joined mutually, and form a joining portion 18 having, for example, a prism shape on the center axis C of the base part 11 (center axis of the holding structure 10). Also, outer end portions in the radial direction of the heat conducting plates 17 are joined to the inner circumferential surface of the base part 11 in an integrated manner and thereby connected so as to transfer heat. Here, the holding structure 10 is one formed by joining and thereby integrating a material forming the base part 11 and the respective heat conducting plates 17 forming the heat conducting parts 16, but may be one integrally molded by, for example, casting.

A length dimension L in an axial direction of the heat conducting plates 17 in this example is uniform in a radial direction, but it is not necessary that the length dimension L in the axial direction of the heat conducting plates 17 be uniform in the radial direction. A thickness t and the length dimension L in the axial direction of the heat conducting plates 17 can be set so that an exhaust heat amount (heat transfer amount) is not less than a certain exhaust heat amount, for example, an exhaust heat amount of no less than 20 W can be obtained while a degree of light loss caused by the heat conducting plates 17 themselves is suppressed to be small. For example, it is preferable that the thickness t of the heat conducting plates 17 be no less than 2 mm and no more than 5 mm, and it is preferable that the length dimension L in the axial direction of the heat conducting plates 17 be within a range of 40 to 80 mm.

As illustrated in FIG. 3, on one side surface 18a of the joining portion 18 of the heat conducting plates 17, a fluorescent member supporting substrate 27 formed of, for example, a sintered body of copper (Cu) and molybdenum (Mo) is provided, and on one surface of the fluorescent member supporting substrate 27, the fluorescent plate 26 forming the fluorescent member 25 is provided. The holding structure 10 and the fluorescent member supporting substrate 27 are joined to each other, and the fluorescent plate 26 and the fluorescent member supporting substrate 27 are joined to each other, so as to transfer heat, by means of, for example, soldering using an Sn—Ag—Cu alloy (not illustrated).

In an end face of an opening on the one end side of the one end-side cylindrical portion 12 of the base part 11 included in the holding structure 10, a window member holding portion 14 formed by a recess portion in which a disk-like window member 30 is received and disposed. An entire outer circumferential surface of the window member 30 is joined to the base part 11 with an adhesive Ad charged in a gap between the outer circumferential surface thereof and an inner circumferential surface of the window member holding portion 14. In FIG. 1, for ease of illustration, the adhesive Ad is indicated with hatching.

The window member 30 is formed of borosilicate glass provided with non-reflecting coating, TEMPAX (registered trademark), for example.

Inside the other end-side cylindrical portion 13 of the base part 11 included in the holding structure 10, a reflector 40 formed of, for example, a parabolic mirror is disposed in such a manner that a reflective surface 40a of the reflector 40 faces an excitation light receiving surface 26a of the fluorescent plate 26. The reflector 40 is disposed in such a manner that an end face of an opening thereof faces and is in contact with a flat surface of the step portion 15 of the base part 11, the flat surface being set as a reflector position defining surface N_{S}, and a back surface of the reflector 40 is supported by an annular disk-like reflector supporting member 45 provided inside the other end-side cylindrical portion 13. An optical axis O_{M} of the reflector 40 is positioned on the center axis C of the base part 11, and a focal point of the reflector 40 is positioned in the excitation light receiving surface 26a of the fluorescent plate 26.

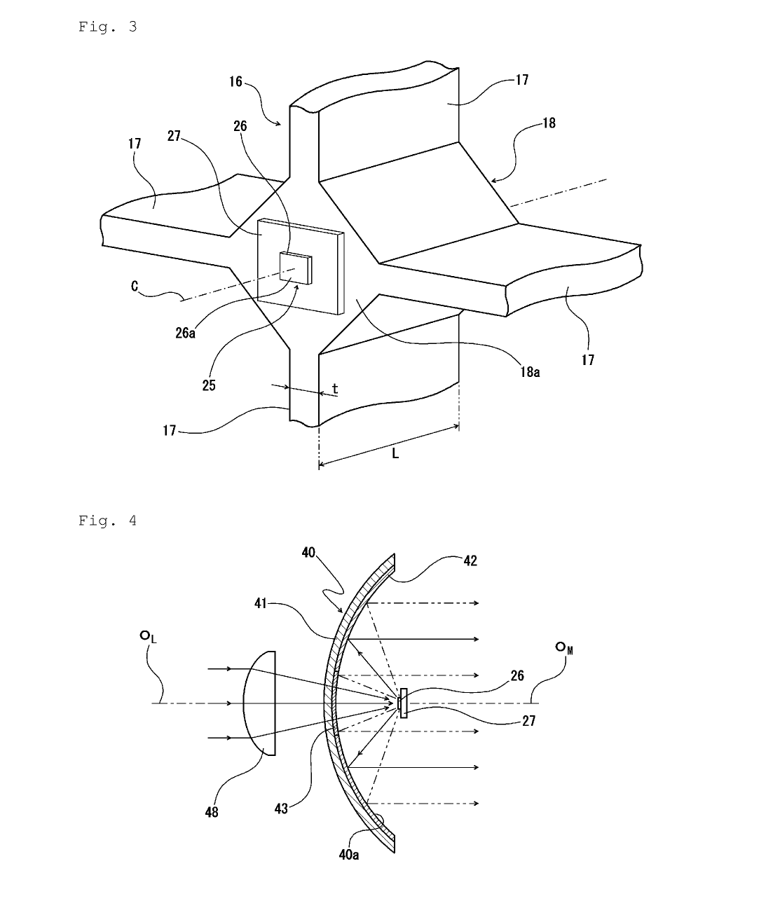

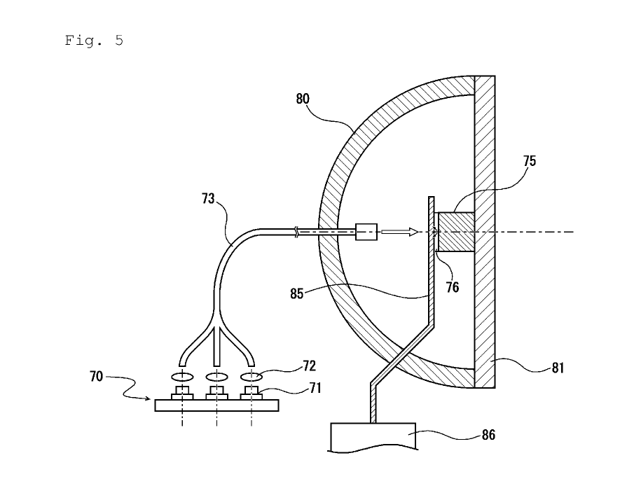

As illustrated in FIG. 4, the reflector 40 is configured by forming a reflective film 42 on an inner surface of a base material 41 formed of, for example, borosilicate glass. The reflective film 42 includes an excitation light transmission portion 43 at a center portion thereof, the excitation light transmission portion 43 transmitting excitation light (solid arrows in FIG. 4) and reflecting fluorescence (alternate long and two short dashes line arrows in FIG. 4) from the fluorescent plate 26, and a circumferential edge portion of the excitation light transmission portion 43 has a function that reflects excitation light and fluorescence.

The reflective film 42 is formed of, for example, a dielectric multi-layer film formed by alternately disposing titanium oxide (TiO₂) layers and silicon oxide (SiO₂) layers. The excitation light transmission portion 43 can be provided by designing a film thickness and the number of layers of the dielectric multi-layer film so as to transmit excitation light and reflect fluorescence. The circumferential edge portion of the excitation light transmission portion 43 is provided by adjusting a film design of the dielectric multi-layer film so as to reflect both excitation light and fluorescence.

The reflector 40 may be formed of an enhanced reflection mirror formed by attaching a dielectric film of MgF₂ to a base material 41 of Ag having high reflectance in a visible range.

An end face of the opening on the other side of the other end-side cylindrical portion 13 of the base part 11 included in the holding structure 10, a disk-like occluding member (back plate) 35 is provided with a seal member 33 formed of, for example, an O-ring between the end face and the occluding member 35. The occluding member 35 is fixed to the base part 11 via, for example, screw fastening so that the seal member 33 is pressed.

As described above, the opening on the one side of the base part 11 is occluded by the window member 30. Therefore, a fluorescent member disposition space S defined by the holding structure 10, the window member 30 and the occluding member 35, in which the fluorescent plate 26 is positioned, is a closed space.

In the occluding member 35, a plurality of (for example, three) excitation light introduction holes 36 penetrating the occluding member 35 in a thickness direction and extending along the center axis C of the base part 11 of the holding structure 10 are formed. At the opposite portion to each excitation light introduction hole 36, a connector 37 for an optical fiber 55 that guides excitation light from an excitation light source 50 is provided. Inside each excitation light introduction hole 36, for example, a collimator lens 46 is disposed in such a manner that an optical axis thereof is in alignment with a center axis of the excitation light introduction hole 36.

On one end surface of the occluding member 35, a cylindrical lens holding member 47 is provided, and a condenser lens 48 that concentrates excitation light from the respective excitation light introduction holes 36 and allows to apply to the fluorescent plate 26 is held by the lens holding member 47. As illustrated in FIG. 4, an optical axis O_{L} of the condenser lens 48 is in alignment with the optical axis O_{M} of the reflector 40. The configuration in which excitation light from each of the plurality of excitation light introduction holes 36 is condensed by the condenser lens 48 and applied to the fluorescent plate 26 enables the fluorescent plate 26 to excite to emit light with high efficiency.

The fluorescent light source apparatus includes a plurality of excitation light sources 50 corresponding to the respective connectors 37 provided at the occluding member 35, and excitation light from each excitation light source 50 is introduced to the corresponding excitation light introduction hole 36 via the corresponding LD optical fiber 55.

Each excitation light source 50 includes a plurality of laser light sources 51 each comprising an LD element 52 and a condenser lens (collective lens) 53. The LD elements 52 are formed of, for example, respective semiconductor lasers that emit laser light of a same emission wavelength, and more specifically, for example, those that emit blue laser light having an oscillation wavelength of 455 nm are used.

Each optical fiber 55 is formed of, for example, a fiber bundle formed by bundling optical fiber element wires corresponding to the respective laser light sources 51.

In an example configuration of the above fluorescent light source apparatus, an outer diameter of the base part 11 of the holding structure 10 is 260 mm, the thickness t of the heat conducting plate 17 is 2 mm, the length dimension L in the axial direction of the heat conducting plate 17 is 50 mm, the length dimension in the radial direction of the heat conducting plate 17 is 110 mm, longitudinal and lateral dimensions of the YAG (Ce) fluorescent plate (fluorescent member) 26 are 5 mm×5 mm, a thickness of the fluorescent plate 26 is 0.15 mm, longitudinal and lateral dimensions of the fluorescent member supporting substrate 27 are 15 mm×15 mm, and a thickness of the fluorescent member supporting substrate 27 is 0.7 mm. A distance in the axial direction between the excitation light receiving surface 26a of the fluorescent plate 26 and the reflector position defining surface N_{S} is 5 mm.

The number of the excitation light sources 50 is three, and the number of the laser light sources 51 forming each excitation light source 50 is eight (total of 24 in the fluorescent light source apparatus). Each LD element 52 has an oscillation wavelength of 455 nm and an output of 2.2 W.

In such configuration as above, where a temperature difference (T1−T2) between a temperature T1 of the fluorescent plate 26 and a temperature T2 of an outer circumferential surface of the holding structure 10 is, for example, 40° C., an exhaust heat amount (heat transfer amount) of around 30 W can be achieved.

In the above fluorescent light source apparatus, excitation light from each of the plurality of excitation light sources 50 is guided by the corresponding optical fiber 55 and enters the corresponding excitation light introduction hole 36 in the occluding member 35. Here, in each excitation light source 50, laser light (blue light) emitted from the LD element 52 in each of the plurality of laser light sources 51 is condensed by the relevant condenser lens 53 as excitation light and enters the corresponding optical fiber element wire in the relevant optical fiber 55. Consequently, excitation light from each of the plurality of laser light sources 51 in one excitation light source 50 enters the inside of a common excitation light introduction hole 36. The excitation light (indicated by solid arrows in FIG. 2) entered the inside of the excitation light introduction hole 36 is formed into parallel light by the relevant collimator lens 46 and enters the condenser lens 48. The excitation light entered the condenser lens 48 is applied to the excitation light receiving surface 26a of the fluorescent plate 26 via the excitation light transmission portion 43 of the reflector 40 while being condensed. As a result of the application of the excitation light to the fluorescent plate 26, fluorescence (indicated by alternate long and two short dashes line arrows in FIG. 2) emitted from the fluorescent plate 26 is reflected by the reflector 40 and converted into parallel light. The fluorescence reflected by the reflector 40 is mixed with the reflected light (blue light) by the reflector 40 resulting from reflection of the laser light reflected by the excitation light receiving surface 26a of the fluorescent plate 26 and is applied via the window member 30 as white light.

Meanwhile, heat generated in the fluorescent plate 26 as a result of the application of the laser light thereto is transferred to the base part 11 via the respective heat conducting plates 17 in the holding structure 10 and is radiated to the outside from the entire base part 11 as a result of the outer circumferential surface of the holding structure 10 mainly functioning as a heat radiating surface.

Therefore, according to the above fluorescent light source apparatus, basically, heat generated in the fluorescent plate 26 is transferred to the base part 11 via the respective heat conducting plates 17 in the holding structure 10 and radiated to the outside from the entire base part 11. Thus, a decrease in amount of fluorescence generated from the fluorescent plate 26 due to temperature quenching accompanying an increase in temperature of the fluorescent plate 26 can be avoided. In addition, a degree of change in positional relationship between the fluorescent plate 26 and an optical component such as the reflector 40 or the condenser lens 48 accompanying an increase in temperature of the holding structure 10 can be suppressed to be small. In other words, in energy of laser light entering the fluorescent plate 26, the part of the energy not contributed to excitation of the fluorescent substance and the part of the energy not reflected by the fluorescent plate 26 are converted into heat energy to heat the holding structure 10 via the fluorescent member supporting substrate 27. Also, the fluorescence reflected by the reflector 40 and a part of the laser light enter and are absorbed by the heat conducting plate 17, thereby causing increment of the temperature of the holding structure 10. As a result, heat deformation of the holding structure 10 itself is caused by heat expansion of the base part 11 of the holding structure 10. However, in the above fluorescent light source apparatus, the holding structure 10 which holds the fluorescent plate 26 together with optical components such as the reflector 40, has a symmetric structure with the center axis C of the base part 11 as a symmetry axis (axisymmetry). Thus, a displacement in an axial position and a radial position of the joining portion 18 positioned at a center of the holding structure 10 is compensated for, and thus a displacement of a position of the excitation light receiving surface 26a of the fluorescent plate 26 relative to the reflector 40 can be suppressed to be small.

Therefore, the fluorescent light source apparatus having the above-described configuration can stably provide a high light output over a long period of time.

Since the fluorescent member disposition space S is a closed space, occurrence of problems such as a decrease in light emission efficiency of the fluorescent plate 26 and deterioration of the fluorescent plate 26 itself due to entry of water and/or entry of dust and the like into the fluorescent member disposition space S can be avoided.

Although an embodiment of the present invention has been described above, the present invention is not limited to the above-described embodiment and various changes can be made.

For example, if a heat conducting part of a holding structure includes a plurality of heat conducting plates, the number and a disposition pattern of heat conducting plates are not specifically limited as long as the holding structure has an axisymmetric structure. For example, a configuration in which three flat plate-like heat conducting plates are disposed at equal angular intervals (intervals of 120°) in a circumferential direction or a configuration in which five flat plate-like heat conducting plates are disposed at equal angular intervals (intervals of 72°), in a cross-section perpendicular to a center axis of a base part, may be employed. Each of such holding structures has a symmetric structure with a center line in a thickness direction of one heat conducting plate as a symmetry axis (axisymmetric structure).

In a fluorescent light source apparatus according to the present invention, an outer circumferential surface of a holding structure mainly functions as a heat radiating surface from which heat generated in a fluorescent member is radiated, and thus the outer circumferential surface of the holding structure may include an uneven structure for heat radiation, which increases the heat release area.

Although a specific configuration of the heat-radiating uneven structure is not specifically limited, the heat-radiating uneven structure can be formed by heat-radiating fins provided integrally with the outer circumferential surface of the holding structure.

Furthermore, a closed space in which the fluorescent member is positioned may be formed by the holding structure, the window member and the reflector. Such configuration can be provided by, for example, joining the reflector to a base part of the holding structure via, for example, an adhesive.

### REFERENCE SIGNS LIST

10 holding structure
11 base part (rim)
12 one end-side cylindrical portion
13 other end-side cylindrical portion
14 window member holding portion
15 step portion
16 heat conducting part (spoke)
17 heat conducting plate
18 joining portion
18a one side surface
25 fluorescent member
26 fluorescent plate
26a excitation light receiving surface
27 fluorescent member supporting substrate
30 window member
33 seal member
35 occluding member
36 excitation light introduction hole
37 connector
40 reflector
40a reflective surface
41 base material
42 reflective film
43 excitation light transmission portion
45 reflector supporting member
46 collimator lens
47 lens holding member
48 condenser lens
50 excitation light source
51 laser light source
52 LD element
53 condenser lens (collective lens)
55 optical fiber
60 support leg portion
70 excitation light source
71 semiconductor laser
72 aspherical lens
73 optical fiber
75 light-emitting section
76 spacer layer
80 reflector
81 transparent plate
85 heat transfer member
86 cooling section
Ad adhesive
C center axis of base part
O_{L} optical axis of condenser lens
O_{M} optical axis of reflector
S fluorescent member disposition space

1. A fluorescent light source apparatus comprising a fluorescent member that generates fluorescence upon application of excitation light thereto, and a reflector having a reflective surface disposed so as to face an excitation light receiving surface of the fluorescent member, wherein:
the fluorescent member and the reflector are held by a common holding structure formed of a heat conductive material, the holding structure including a cylindrical base part and a heat conducting part formed so as to extend from an inner circumferential surface of the base part toward a center axis of the base part; and
the fluorescent member is held so as to be positioned on the center axis of the base part, on a side surface of the heat conducting part of the holding structure, the side surface facing the reflective surface of the reflector.

2. The fluorescent light source apparatus according to claim 1, wherein:
the holding structure includes a plurality of the heat conducting parts having a plate-like shape with respective inner end portions mutually joined on the center axis of the base part; and
each of the plurality of the heat conducting parts is disposed in such a manner that the holding structure has an axisymmetric structure.

3. The fluorescent light source apparatus according to claim 1, wherein an opening on a one-end side of the holding structure is occluded by a window member and an opening on the other-end side of the holding structure is occluded by an occluding member, whereby a space in which the fluorescent member is positioned is a closed space.
